(19) United States
(12) Patent Application Publication
(10) Pub. No.: US 2009/0290132 A1
(43) Pub. Date: Nov. 26, 2009

(54) Image Projection Display System

(76) Inventor: Fergal Shevlin, Dublin 20 (IE)

Correspondence Address: JACOBSON HOLMAN PLLC, 400 SEVENTH STREET N.W., SUITE 600, WASHINGTON, DC, 20004, US

(21) Appl. No.: 12/084,248

(22) PCT Filed: Oct. 27, 2006
(86) PCT No.: PCT/IE2006/000122

§ 371 Date: Apr. 28, 2008

(30) Foreign Application Priority Data
Oct. 27, 2005 (IE) 2005/0722
Jun. 1, 2006 (IE) 2006/0416

(51) Int. Cl. G03B 21/28; H04N 9/31; G03B 21/14

(52) U.S. Cl. 353/69; 348/744; 353/85; 348/E09.025

(57) ABSTRACT

An image projection display system comprises a variable optical property element (1). The element (1) is under direction of a control system (2) and is positioned within an optical system (5), comprising optical elements (5(a, b, c, d, e, f, g)). A source image electronic device (4) receives inputs from a video generation system (7) and is illuminated with light from a photon source (11) filtered by a wavelength-selecting colour wheel (5(b)), under direction of an illumination control system (6). The element 1 comprises a thin Al-coated membrane (150) etched from S^{a}3N4 (151) mounted via spacers (153) over a substrate (152) having actuator pads (154). Circuits (155) supply various control voltages Electrostatic attraction causes the membrane (150) to deform towards the actuator pads (154) when voltages V1, V2, . . . VN are applied to the actuation channels. The control system (2) receives inputs from the illumination control system (6), the video generation system (J), the source image formation device (4), the mechanical positioning and sensing system (12), and vice-versa.

### FIELD OF THE INVENTION

The invention relates to a projection image display system for application such as a video front projector, a rear-projection television, a camera viewfinder, a near-to-eye display, or a photo-lithography system.

### PRIOR ART DISCUSSION

At present, an approach to achieving good projected image quality in such systems is to use an optical system that achieves low image aberration and low image geometric distortion. The optical system can comprise several groups of optical elements, each element having a precise shape and position, and possibly made of materials with different optical properties relative to the others. Such an optical system is complex. This makes it expensive to design and/or manufacture, large in size and/or mass. Also, the reflection that occurs at each refractive optical surface can lead to reduced image brightness and contrast.

If variation of magnification, focus, and/or image geometric distortion are required, a mechanical positioning system moves optical system groups precisely relative to each other. Such a precise mechanical positioning system is expensive to design and/or manufacture and is large in size and/or mass.

If the required vertical and/or horizontal position of the projected image is different to that of the source image, the optical axis of the optical system can be offset with respect to the centre of the source image to shift the projected image while avoiding keystone image geometric distortion. This requires the optical elements of the optical system to have a large diameter relative to the size of the source image in order to achieve sufficient field size with low image aberration and low image geometric distortion.

The part of the optical system that directs light from the photon source onto the source image should achieve illumination appropriate to the state of magnification, focus, and/or image geometric distortion achieved by the part of the optical system that directs light from the source image to form the projected image. This requires both parts of the optical system to have certain imaging characteristics, such as telecentricity, in order to achieve good illumination of the projected image. These characteristics should be maintained throughout variation of magnification, focus, and/or image geometric distortion. This complicates the design and/or manufacture and/or operation of both parts of optical system, leading to the problems of complexity outlined above.

Aspherical elements (e.g. with paraboloidal surfaces) can have superior performance to conventional spherical optical elements in reducing image aberration and image geometric distortion. However there are problems associated with them. They can be more difficult to manufacture precisely, leading to image aberration. Their near optimal performance in one state of an optical system with variable states of magnification and focus is not necessarily optimally suited to other states. They can be difficult to reposition with respect to other elements in the optical system because translation is usually achieved in a screw-like manner with a rotational motion. Any misalignment of the optical axis of the aspherical element with that of the screw mechanism will lead to increased off-axis image aberration.

The observer's perception of the image is an important metric of projected image display quality. If the image has or does not have certain radiometric, geometric, and temporal characteristics then the observer's image perception is adversely affected.

The invention is therefore directed towards providing a projection image display system with good projected image quality with optical systems which are less complex, and/or less expensive, and/or are less large in size and/or mass, and/or achieve low or precise image aberration, and/or achieve low or precise image geometric distortion, and/or achieve increased image contrast, and/or achieve increased image brightness, and/or enhance the observer's perception of the projected image.

### SUMMARY OF THE INVENTION

According to the invention, there is provided an image projection display system comprising a source image formation device, an optical system for projection of the source image, said optical system comprising at least one variable optical property element, and a controller for controlling optical properties of said element according to desired projection display requirements.

In one embodiment, the system further comprises an illumination control system for illumination of the source image

In another embodiment, the controller receives and processes inputs from the illumination control system.

In a further embodiment, the controller receives and processes inputs from the source image formation device.

In one embodiment, the controller receives and processes inputs from a mechanical positioning system.

In another embodiment, the controller receives and processes inputs from a manual adjustment system.

In a further embodiment, the controller receives and processes inputs from an observer eye-tracking system.

In one embodiment, the controller receives and processes inputs from a wavefront sensing system.

In another embodiment, the controller receives and processes inputs from a displayed image sensing system.

In a further embodiment, the controller receives and processes inputs from an environmental condition sensing system.

In one embodiment, the controller operates to introduce or to correct image aberration.

In another embodiment, the controller operates to introduce or to correct image geometric distortion.

In a further embodiment, the controller operates to introduce or to correct aberration in the illumination system.

In one embodiment, the controller operates to introduce or to correct geometric distortion of the exit pupil of an illumination system of the source image formation device.

In another embodiment, the controller comprises a look-up table of data for control values, indexed on inputs.

In a further embodiment, the controller implements a closed-loop control system.

In one embodiment, the controller implements an open-loop control system.

In another embodiment, the controller controls the variable optical property element to change optical geometric and radiometric characteristics including shape and intensity distribution of an area illuminated on the source image formation device without reducing the amount of illumination passing through the system, and thus image brightness.

In a further embodiment, the controller controls the variable optical property element to cause display of images with different aspect ratios.

In one embodiment, the controller causes a change in the shape of an exit pupil of the system, by the variable optical property element modifying the shape of the aperture-limiting stop.

In another embodiment, the stop is an exit pupil of an integrator rod.

In a further embodiment, the stop is a combination of overlapping exit pupils of an array of lenses.

In one embodiment, the variable optical property element comprises a pair of deformable mirrors for anamorphic magnification of the shape of an exit pupil.

In another embodiment, the variable optical property element is a deformable mirror.

In a further embodiment, the variable optical property element comprises a plurality of lenses separated by liquid crystal material the refractive index of which can be varied by the controller.

In one embodiment, the lenses are cylindrical with opposed complementary curvatures.

In another embodiment, the controller varies polarised light to match or to be higher than the refractive index of the lenses, and when the liquid crystal material index of refraction matches that of the lenses, the element acts as a plate of homogeneous index of refraction.

In a further embodiment, the controller operates such that when liquid crystal material index of refraction is higher than that of the lenses the element acts to achieve anamorphic magnification, and a succession of high and low values of refractive index in the liquid crystal material creates a cylindrical lens of uni-axial power having the effect of making light rays in one plane converge while the rays in an orthogonal plane do not.

### DETAILED DESCRIPTION OF THE INVENTION

The invention will be more clearly understood from the following description of some embodiments thereof, given by way of example only with reference to the accompanying drawings in which:—

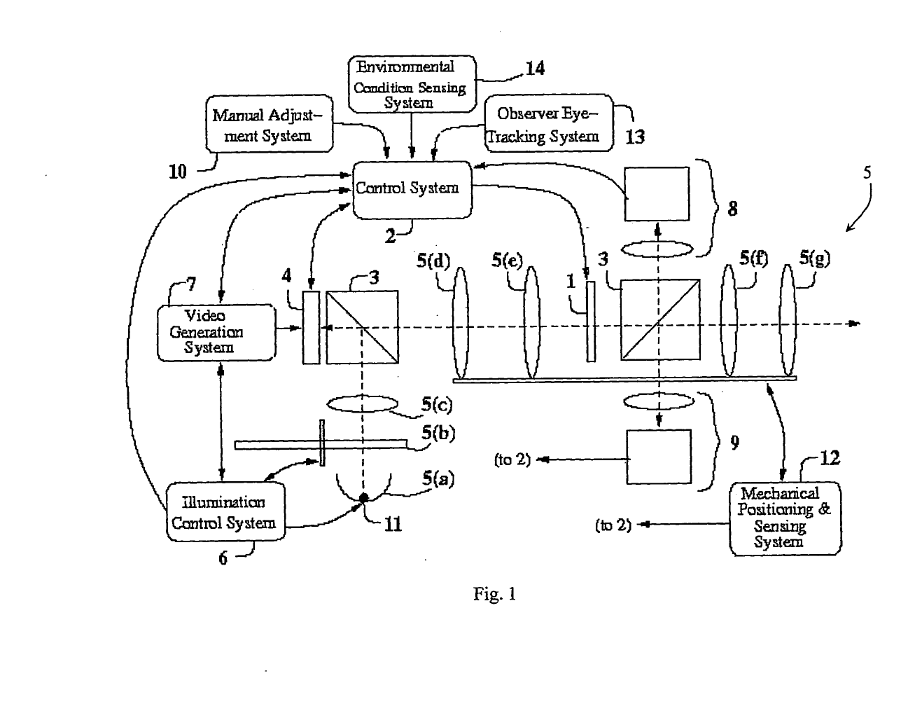

FIG. 1 is a representation of a projection system of the invention incorporating a variable property optical element;

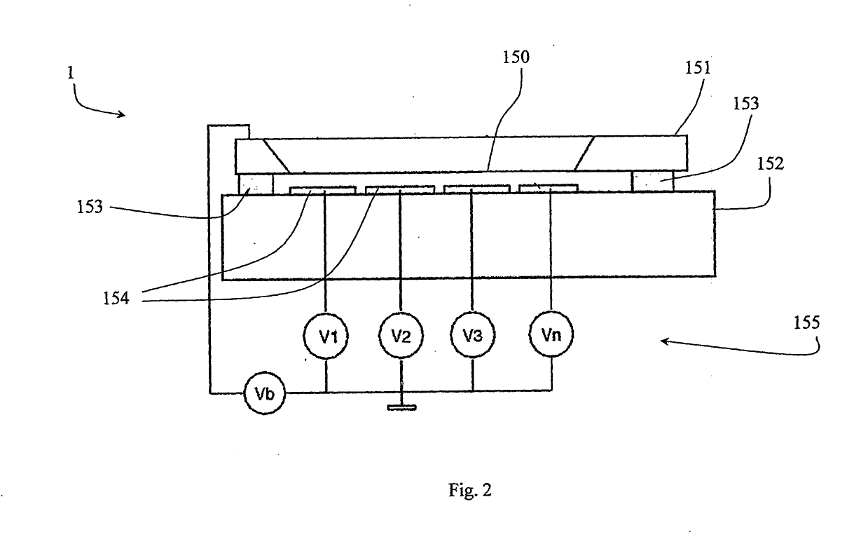

FIG. 2 is a ray-tracing schematic of parts of an alternative projection system of the invention;

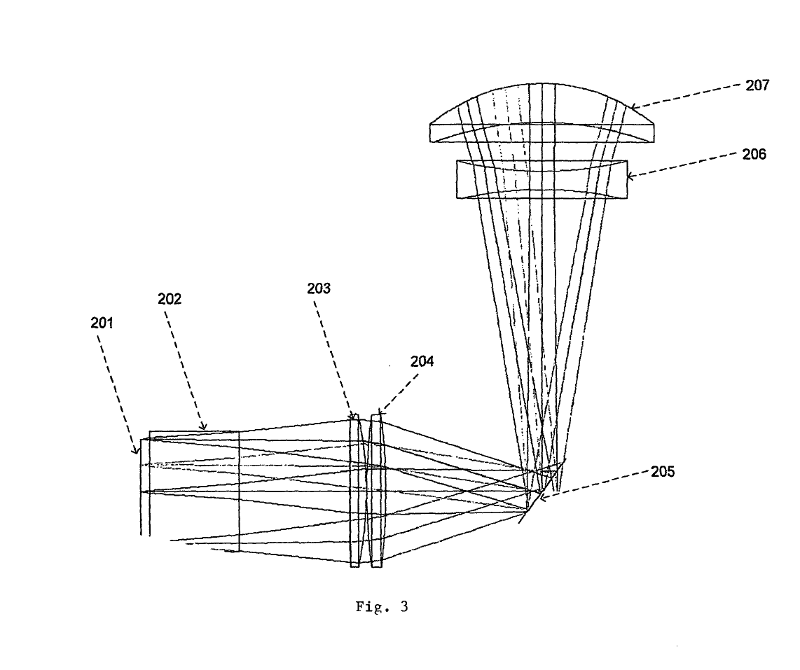

FIG. 3 is a diagram showing a variable property optical element, in this embodiment a micro-machined membrane deformable mirror (MMDM);

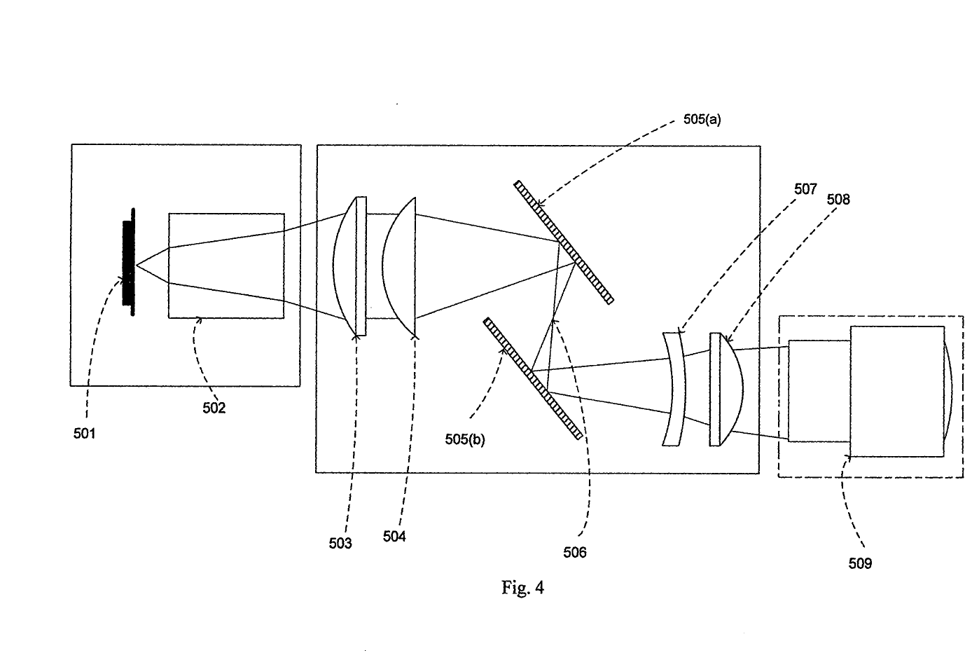

FIG. 4 is a diagram of an optical module including two variable optical property elements, in this embodiment MMDMs arranged so as to achieve variable anamorphic magnification;

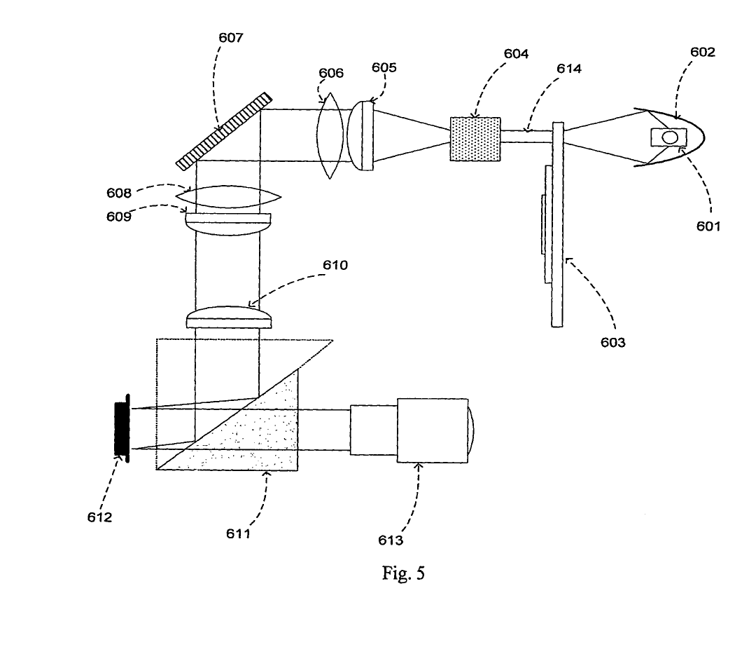

FIG. 5 is a representation of a projection system of the invention incorporating variable property optical elements in the illumination path;

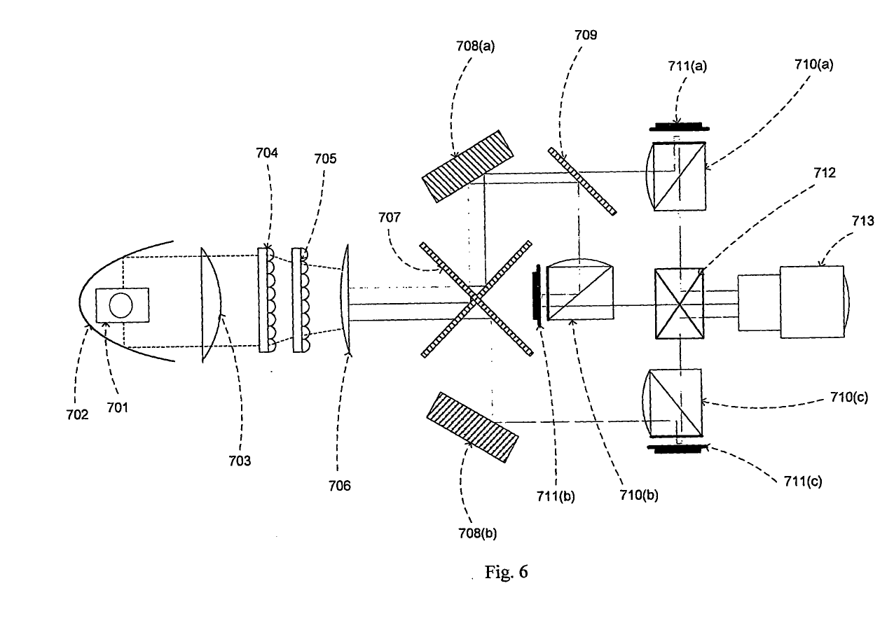

FIG. 6 is another representation of a projection system of the invention incorporating variable property optical elements in the illumination path;

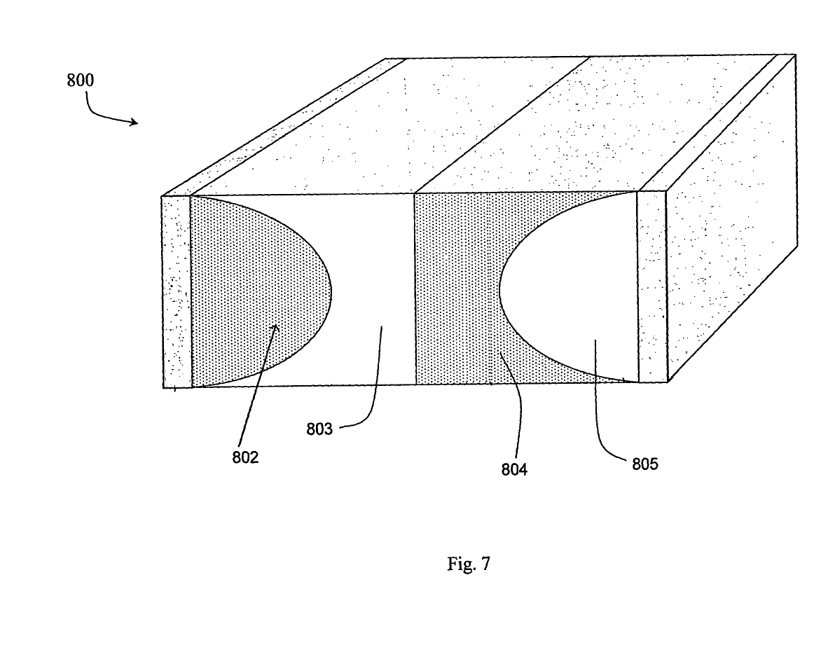

FIG. 7 is a diagram showing a variable optical property element, in this embodiment a sequence of static optical elements with cavities between them filled with a liquid crystal material whose index of refraction can be varied; and

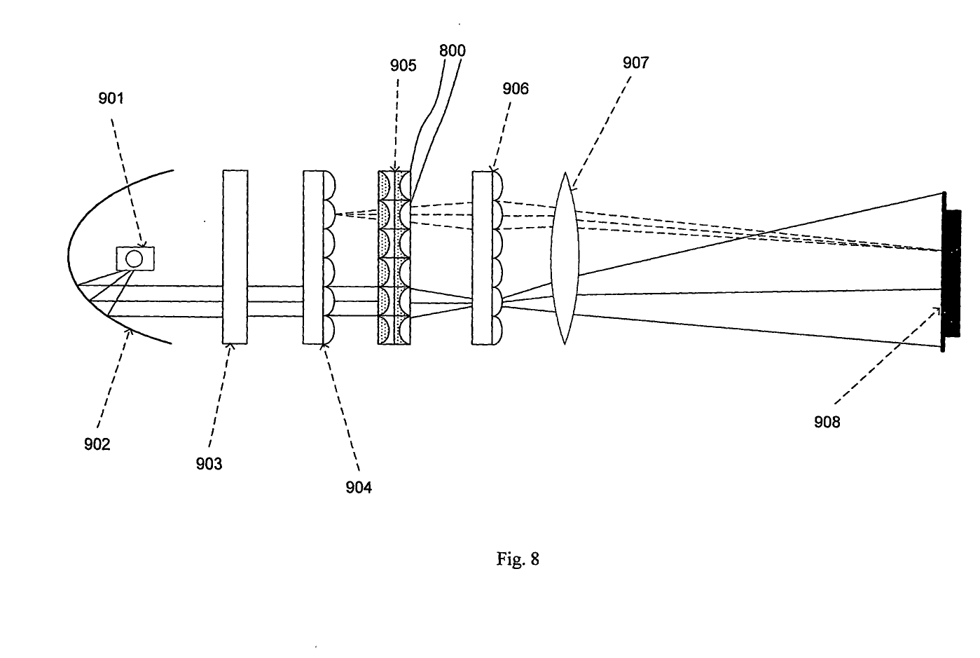

FIG. 8 is another representation of a projection system of the invention incorporating multiple variable property optical elements in the illumination path.

### DESCRIPTION OF THE EMBODIMENTS

Referring to FIG. 1, a projection system comprises a reflective variable optical property element 1. In this diagram, the fold in the optical path due to reflection is not shown. The element 1 is under direction of a control system 2 and is positioned within an optical system 5, comprising optical elements (5(a, b, c, d, e, f, g)) and a beam splitter 3 for directing some light via optics 8 and 9 to the control system 2. A source image forming device 4 receives inputs from a video generation system 7 and is illuminated with light from a photon source 11 filtered by a wavelength-selecting colour wheel 5(b), under direction of an illumination control system 6. There is also a manual adjustment system 10, a mechanical positioning and sensing system 12, an observer eye-tracking system 13, and an environmental condition sensing system 14.

FIG. 2 shows the element 1 of the system of FIG. 1 in more detail. It is a micro-machined membrane deformable mirror (MMDM). The element 1 comprises a thin Al-coated membrane 150 etched from Si3N4 151 mounted via spacers 153 over a substrate 152 having actuator pads 154. Circuits 155 supply various control voltages Electrostatic attraction causes the membrane 150 to deform towards the actuator pads 154 when voltages V1, V2, . . . VN are applied to the actuation channels.

The control system 2 receives inputs from the illumination control system 6, the video generation system 7, the source image formation device 4, the mechanical positioning and sensing system 12, and vice-versa The control system 2 also receives inputs from the manual adjustment system 10 under the direction of an image observer, the image observer eye-tracking system 13, and the environmental condition sensing system 14. Also, the optics 8 are a wavefront sensing system 8 which measures the distortion of light passing through the system, and a displayed image sensing system 9 which measures the quality of the displayed image. Prism beam-splitter cubes 3 are used in a variety of locations for alignment of multiple optical paths.

FIG. 3 is an optical ray-tracing schematic of an alternative optical system for an image projection system. It shows light rays from a single source image forming device 201 being directed onto a reflective variable optical property element 205 of small diameter relative to lenses 203, 204, 206, 207. A prism 202 is used to model part of the optical system required to illuminate the source image forming device 201. The following tables set out data describing the characteristics of the lenses used in the optical system of FIG. 3. The variable optical property element 205 is modelled as a Zernike polynomial reflective surface whose first 13 coefficients are shown.

The lenses 203, 204, 206, 207 are not achromats. Without the variable optical property element 100 correction for the illumination wavelength of each colour field, lenses 203, 204, 206, 207 would cause chromatic aberration in the projected image.

Because the variable optical property element 205 has a small diameter relative to the lenses 203, 204, 206, 207, it is positioned as the aperture-limiting stop near the centre of the system. An alternative that avoids light loss is to insert a reflective variable optical property element 205 into the optical path at the smallest possible small fold angle such that the introduction of astigmatism and related aberrations are minimised.

System/Prescription Data
GENERAL LENS DATA:

| | |
|---|---|
| Surfaces | 15 |
| Stop | 8 |
| System Aperture | Object Cone Angle = 5 |
| Glass Catalogs | SCHOTT |
| Ray Aiming | Off |
| Apodization | Uniform, factor = 0.00000E+000 |
| Effective Focal Length | 34.84571 (in air at system |
| | temperature and pressure) |
| Effective Focal Length | 34.84571 (in image space) |
| Back Focal Length | 10063.96 |
| Total Track | 5067.915 |
| Image Space F/# | 0.2146046 |
| Paraxial Working F/# | 1309.165 |
| Working F/# | 363.7106 |
| Image Space NA | 0.0003819228 |
| Object Space NA | 0.08715574 |
| Stop Radius | 3.418032 |
| Paraxial Image Height | 1996.381 |
| Paraxial Magnification | 229.0742 |
| Entrance Pupil Diameter | 162.3717 |
| Entrance Pupil Position | 925.9583 |
| Exit Pupil Diameter | 6.096209 |
| Exit Pupil Position | 5065.268 |
| Field Type | Object height in Millimeters |
| Maximum Field | 8.715 |
| Primary Wave | 0.55 |
| Lens Units | Millimeters |
| Angular Magnification | −26.63486 |

Fields: 4
Field Type: Object height in Millimeters

| # | X-Value | Y-Value | Weight |
|---|---|---|---|
| 1 | 0.000000 | 0.000000 | 1.000000 |
| 2 | 0.000000 | −8.715000 | 1.000000 |
| 3 | 0.000000 | 8.715000 | 1.000000 |
| 4 | 0.000000 | 4.357500 | 1.000000 |

Vignetting Factors

| # | VDX | VDY | VCX | VCY | VAN |
|---|---|---|---|---|---|
| 1 | 0.000000 | 0.000000 | 0.000000 | 0.000000 | 0.000000 |
| 2 | 0.000000 | 0.000000 | 0.000000 | 0.000000 | 0.000000 |
| 3 | 0.000000 | 0.000000 | 0.000000 | 0.000000 | 0.000000 |
| 4 | 0.000000 | 0.000000 | 0.000000 | 0.000000 | 0.000000 |

Wavelengths: 1
Units: μm

| # | Value | Weight |
|---|---|---|
| 1 | 0.550000 | 1.000000 |

SURFACE DATA SUMMARY:

| Label | Surf Type | Comment | Radius | Thickness | Glass | Diameter | Conic |
|---|---|---|---|---|---|---|---|
| 201 | OBJ STANDARD | | Infinity | 2 | | 17.43 | 0 |
| 202 | 1 STANDARD | TIR PRISM | Infinity | 20 | BK7 | 20 | 0 |
| — | 2 STANDARD | | Infinity | 24.54182 | | 20 | 0 |
| 203 | 3 STANDARD | CLL3735 | 420.1681 | 3.7 | BK7 | 25.4 | 0 |
| — | 4 STANDARD | | −45.55186 | 0.139324 | | 25.4 | 0 |
| 204 | 5 STANDARD | CBX10655 | 76.54038 | 4.2 | BK7 | 25.4 | 0 |
| — | 6 STANDARD | | −76.54038 | 35 | | 25.4 | 0 |
| — | 7 COORDBRK | | — | 0 | | — | — |
| 205 | STO STANDARD | MMDM | −2000 | 0 | MIRROR | 15 | 0 |
| — | 9 COORDBRK | | — | 0 | | — | — |
| — | 10 STANDARD | | Infinity | −50.2578 | | 0 | 0 |
| — | 11 STANDARD | CBV11055 | 103.5304 | −3 | BK7 | 35.25655 | 0 |
| 206 | 12 STANDARD | | −103.5304 | −8.157 | | 38.00026 | 0 |
| — | 13 STANDARD | CMN11242 | 90 | −6.5 | BK7 | 47.85171 | 0 |
| 207 | 14 STANDARD | | 49.319 | −5000 | | 50.00004 | 0 |
| — | IMA STANDARD | | Infinity | | | 2870.012 | 0 |

SURFACE DATA DETAIL:

| | |
|---|---|
| Surface OBJ | STANDARD |
| Surface 1 | STANDARD TIR PRISM |
| Aperture | Floating Aperture |
| Maximum Radius | 10 |
| Surface 2 | STANDARD |
| Aperture | Floating Aperture |
| Maximum Radius | 10 |
| Surface 3 | STANDARD CLL3735 |
| Aperture | Floating Aperture |
| Maximum Radius | 12.7 |
| Surface 4 | STANDARD |
| Aperture | Floating Aperture |
| Maximum Radius | 12.7 |
| Surface 5 | STANDARD CBX10655 |
| Aperture | Floating Aperture |
| Maximum Radius | 12.7 |
| Surface 6 | STANDARD |
| Aperture | Floating Aperture |
| Maximum Radius | 12.7 |
| Surface 7 | COORDBRK |
| Decenter X | 0 |
| Decenter Y | 0 |
| Tilt About X | 45 |
| Tilt About Y | 0 |
| Tilt About Z | 0 |
| Order | Decenter then tilt |
| Surface STO | STANDARD BEAMSPLITTER |
| Aperture | Floating Aperture |
| Maximum Radius | 7.5 |
| Surface 9 | COORDBRK |
| Decenter X | 0 |
| Decenter Y | 0 |
| Tilt About X | 45 |
| Tilt About Y | 0 |
| Tilt About Z | 0 |
| Order | Decenter then tilt |
| Surface 10 | STANDARD |
| Aperture | Floating Aperture |
| Maximum Radius | 0 |
| Surface 11 | STANDARD CBV11055 |
| Aperture | Floating Aperture |
| Maximum Radius | 17.62828 |
| Surface 12 | STANDARD |
| Aperture | Floating Aperture |
| Maximum Radius | 19.00013 |
| Surface 13 | STANDARD CMN11242 |
| Aperture | Floating Aperture |
| Maximum Radius | 23.92585 |
| Surface 14 | STANDARD |
| Aperture | Floating Aperture |
| Maximum Radius | 25.00002 |
| Surface IMA | STANDARD |

EDGE THICKNESS DATA:

| Surf | X-Edge | Y-Edge |
|---|---|---|
| OBJ | 2.000000 | 2.000000 |
| 1 | 20.000000 | 20.000000 |
| 2 | 24.733797 | 24.733797 |
| 3 | 1.701812 | 1.701812 |
| 4 | 3.006514 | 3.006514 |
| 5 | 2.078039 | 2.078039 |
| 6 | 36.060980 | 36.060980 |
| 7 | −0.014063 | −0.014063 |
| STO | 0.014063 | 0.014063 |
| 9 | 0.000000 | 0.000000 |
| 10 | −48.745965 | −48.745965 |
| 11 | −6.270241 | −6.270241 |
| 12 | −3.160070 | −3.160070 |
| 13 | −2.932615 | −2.932615 |
| 14 | −5006.805910 | −5006.805910 |
| IMA | 0.000000 | 0.000000 |

INDEX OF REFRACTION DATA:

| Surf | Glass | Temp | Pres | 0.550000 |
|---|---|---|---|---|
| 0 | | 20.00 | 1.00 | 1.00000000 |
| 1 | BK7 | 20.00 | 1.00 | 1.51852239 |
| 2 | | 20.00 | 1.00 | 1.00000000 |
| 3 | BK7 | 20.00 | 1.00 | 1.51852239 |
| 4 | | 20.00 | 1.00 | 1.00000000 |
| 5 | BK7 | 20.00 | 1.00 | 1.51852239 |
| 6 | | 20.00 | 1.00 | 1.00000000 |
| 7 | <CRD BRK> | | | 1.00000000 |
| 8 | MIRROR | 20.00 | 1.00 | 1.00000000 |
| 9 | <CRD BRK> | | | 1.00000000 |
| 10 | | 20.00 | 1.00 | 1.00000000 |
| 11 | BK7 | 20.00 | 1.00 | 1.51852239 |
| 12 | | 20.00 | 1.00 | 1.00000000 |
| 13 | BK7 | 20.00 | 1.00 | 1.51852239 |
| 14 | | 20.00 | 1.00 | 1.00000000 |
| 15 | | 20.00 | 1.00 | 1.00000000 |

THERMAL COEFFICIENT OF EXPANSION DATA:

| Surf | Glass | TCE *10E−6 |
|---|---|---|
| 0 | | 0.00000000 |
| 1 | BK7 | 7.10000000 |
| 2 | | 0.00000000 |
| 3 | BK7 | 7.10000000 |
| 4 | | 0.00000000 |
| 5 | BK7 | 7.10000000 |
| 6 | | 0.00000000 |
| 7 | <CRD BRK> | 0.00000000 |
| 8 | MIRROR | 0.00000000 |
| 9 | <CRD BRK> | 0.00000000 |
| 10 | | 0.00000000 |
| 11 | BK7 | 7.10000000 |
| 12 | | 0.00000000 |
| 13 | BK7 | 7.10000000 |
| 14 | | 0.00000000 |
| 15 | | 0.00000000 |

F/# DATA:
F/# calculations consider vignetting factors and ignore surface apertures.
Wavelength: 0.550000

| # | Field | Tan | Sag |
|---|---|---|---|
| 1 | 0.0000, 0.0000 mm: | 313.0355 | 452.6098 |
| 2 | 0.0000, −8.7150 mm: | 144.8805 | 437.3062 |
| 3 | 0.0000, 8.7150 mm: | 557.5611 | 1343.3662 |
| 4 | 0.0000, 4.3575 mm: | 500.0880 | 785.9292 |

GLOBAL VERTEX COORDINATES, ORIENTATIONS, AND ROTATION/OFFSET MATRICES:
Reference Surface: 2

| Surf | R11 | R12 | R13 | X | |
|---|---|---|---|---|---|
| | R21 | R22 | R23 | Y | |
| | R31 | R32 | R33 | Z | |
| 0 | 1.0000000000 | 0.0000000000 | 0.0000000000 | 0.000000000E+000 | |
| | 0.0000000000 | 1.0000000000 | 0.0000000000 | 0.000000000E+000 | |
| | 0.0000000000 | 0.0000000000 | 1.0000000000 | −2.200000000E+001 | |
| 1 | 1.0000000000 | 0.0000000000 | 0.0000000000 | 0.000000000E+000 | TIR PRISM |
| | 0.0000000000 | 1.0000000000 | 0.0000000000 | 0.000000000E+000 | |
| | 0.0000000000 | 0.0000000000 | 1.0000000000 | −2.000000000E+001 | |
| 2 | 1.0000000000 | 0.0000000000 | 0.0000000000 | 0.000000000E+000 | |
| | 0.0000000000 | 1.0000000000 | 0.0000000000 | 0.000000000E+000 | |
| | 0.0000000000 | 0.0000000000 | 1.0000000000 | 0.000000000E+000 | |
| 3 | 1.0000000000 | 0.0000000000 | 0.0000000000 | 0.000000000E+000 | CLL3735 |
| | 0.0000000000 | 1.0000000000 | 0.0000000000 | 0.000000000E+000 | |
| | 0.0000000000 | 0.0000000000 | 1.0000000000 | 2.454181800E+001 | |
| 4 | 1.0000000000 | 0.0000000000 | 0.0000000000 | 0.000000000E+000 | |
| | 0.0000000000 | 1.0000000000 | 0.0000000000 | 0.000000000E+000 | |
| | 0.0000000000 | 0.0000000000 | 1.0000000000 | 2.824181800E+001 | |
| 5 | 1.0000000000 | 0.0000000000 | 0.0000000000 | 0.000000000E+000 | CBX10655 |
| | 0.0000000000 | 1.0000000000 | 0.0000000000 | 0.000000000E+000 | |
| | 0.0000000000 | 0.0000000000 | 1.0000000000 | 2.838114200E+001 | |
| 6 | 1.0000000000 | 0.0000000000 | 0.0000000000 | 0.000000000E+000 | |
| | 0.0000000000 | 1.0000000000 | 0.0000000000 | 0.000000000E+000 | |
| | 0.0000000000 | 0.0000000000 | 1.0000000000 | 3.258114200E+001 | |
| 7 | 1.0000000000 | 0.0000000000 | 0.0000000000 | 0.000000000E+000 | |
| | 0.0000000000 | 0.7071067812 | −0.7071067812 | 0.000000000E+000 | |
| | 0.0000000000 | 0.7071067812 | 0.7071067812 | 6.758114200E+001 | |
| 8 | 1.0000000000 | 0.0000000000 | 0.0000000000 | 0.000000000E+000 | BEAMSPLITTER |
| | 0.0000000000 | 0.7071067812 | −0.7071067812 | 0.000000000E+000 | |
| | 0.0000000000 | 0.7071067812 | 0.7071067812 | 6.758114200E+001 | |
| 9 | 1.0000000000 | 0.0000000000 | 0.0000000000 | 0.000000000E+000 | |
| | 0.0000000000 | −0.0000000000 | −1.0000000000 | 0.000000000E+000 | |
| | 0.0000000000 | 1.0000000000 | −0.0000000000 | 6.758114200E+001 | |
| 10 | 1.0000000000 | 0.0000000000 | 0.0000000000 | 0.000000000E+000 | |
| | 0.0000000000 | −0.0000000000 | −1.0000000000 | 0.000000000E+000 | |
| | 0.0000000000 | 1.0000000000 | −0.0000000000 | 6.758114200E+001 | |
| 11 | 1.0000000000 | 0.0000000000 | 0.0000000000 | 0.000000000E+000 | CBV11055 |
| | 0.0000000000 | −0.0000000000 | −1.0000000000 | 5.025780000E+001 | |
| | 0.0000000000 | 1.0000000000 | −0.0000000000 | 6.758114200E+001 | |
| 12 | 1.0000000000 | 0.0000000000 | 0.0000000000 | 0.000000000E+000 | |
| | 0.0000000000 | −0.0000000000 | −1.0000000000 | 5.325780000E+001 | |
| | 0.0000000000 | 1.0000000000 | −0.0000000000 | 6.758114200E+001 | |
| 13 | 1.0000000000 | 0.0000000000 | 0.0000000000 | 0.000000000E+000 | CMN11242 |
| | 0.0000000000 | −0.0000000000 | −1.0000000000 | 6.141480000E+001 | |
| | 0.0000000000 | 1.0000000000 | −0.0000000000 | 6.758114200E+001 | |
| 14 | 1.0000000000 | 0.0000000000 | 0.0000000000 | 0.000000000E+000 | |
| | 0.0000000000 | −0.0000000000 | −1.0000000000 | 6.791480000E+001 | |
| | 0.0000000000 | 1.0000000000 | −0.0000000000 | 6.758114200E+001 | |
| 15 | 1.0000000000 | 0.0000000000 | 0.0000000000 | 0.000000000E+000 | |
| | 0.0000000000 | −0.0000000000 | −1.0000000000 | 5.067914800E+003 | |
| | 0.0000000000 | 1.0000000000 | −0.0000000000 | 6.758114200E+001 | |

ELEMENT VOLUME DATA:
For centered elements with plane or spherical circular faces, exact volumes are computed
by assuming edges are squared up to the larger of the front and back radial aperture.
For all other elements, approximate volumes are numerically integrated
to 0.1% accuracy. Zero volume means the volume cannot be accurately computed.
Single elements that are duplicated in the Lens Data Editor for ray tracing
purposes may be listed more than once yielding incorrect total mass estimates.

| | Volume cc | Density g/cc | Mass g |
|---|---|---|---|
| Element surf 1 to 2 | 6.283185 | 2.510000 | 15.770795 |
| Element surf 3 to 4 | 1.371658 | 2.510000 | 3.442862 |
| Element surf 5 to 6 | 1.591815 | 2.510000 | 3.995457 |
| Element surf 11 to 12 | 5.371504 | 2.510000 | 13.482475 |
| Element surf 13 to 14 | 9.675091 | 2.510000 | 24.284479 |
| Total Mass: | | | 60.976067 |

CARDINAL POINTS:
Object space positions are measured with respect to surface 1.
Image space positions are measured with respect to the image surface.
The index in both the object space and image space is considered.

| W = 0.550000 (Primary) | Object Space | Image Space |
|---|---|---|
| Focal Length | −34.845705 | −34.845705 |
| Focal Planes | −2.152115 | 5063.959472 |
| Principal Planes | 32.693590 | 5098.805177 |
| Anti-Principal Planes | −36.997821 | 5029.113767 |
| Nodal Planes | −36.997821 | 5029.113767 |
| Anti-Nodal Planes | 32.693590 | 5098.805177 |

The optical system illustrated in FIG. 3, the parameters of which are set out in the tables above, uses a 15 mm diameter, 37-channel, MMDM (from Flexible Optical B.V.) It requires an actuation voltage up to circa 300V on each of its 37 channels. Digital control signals are output by the control system for each channel. These are converted to low analogue voltages in the range 0V to 5V by a 37-channel digital-to-analogue converter (DAC.) The low analogue voltages are subsequently amplified into the required actuation range by a 37-channel high voltage amplifier.

Control signals are determined prior to system operation through a calibration procedure where a wavefront sensor (e.g. a Hartmann mask or a Shack-Hartmann microlens array) is used to measure wavefront shape after the optical system, and an iterative closed-loop control algorithm is used to determine the appropriate control signals for the variable optical property element to correct or introduce distortion. Alternatively, an optical ray-tracing simulation system (e.g. Zemax (R) from Zemax Development Corporation) can be used to model the optical system and thus compute wavefront shape. Another alternative is to use a combination of measurement and modelling.

FIG. 4 illustrates a further alternative optical system including two variable optical property elements. A microdisplay 501 reflects light coming from an illumination system through a prism 502. Diverging light is concentrated by a group of lenses 503 and 504. Variable optical property MMDMs 505(a) and 505(b) are tilted at certain angles and are located before and after an intermediate image plan 506 to introduce complementary deflections to the light rays. The deformable mirrors 505(a) and 505(b) introduce asymmetric magnification, i.e. different in the plane of the drawing than in the plan perpendicular to the drawing. This achieves the anamorphic magnification of the image. Light then passes through a second group of lenses 507 and 508 which generate a virtual image to be magnified and projected through a projection lens system 509.

FIG. 5 illustrates a still further optical system for image projection, for illumination of a single electronic image forming device 612 with light from a photon source 601. A reflector 602 captures light emitted in multiple directions from the photon source 601 and directs it through a colour filter wheel 603 into the entrance pupil of an integrator rod 614 which helps to more evenly distribute illumination intensity. An optical sub-system 604 achieves anamorphic magnification of the shape of the integrator rod 614 exit pupil. Lenses 605 and 606 direct light onto a variable optical property MMDM 607 such that it fills its aperture. The MMDM 607 is used to remove or introduce aberration or distortion across the illumination field on the device 612 formed by lenses 608, 609, 610, and 611. The image from 612 is magnified and projected through a projection lens system 613.

FIG. 6 shows a further optical system for image projection, in particular those elements required for illumination of three electronic image forming devices 711(a), 711(b), and 711(c), with light from a photon source 701. A reflector 702 captures light emitted in multiple directions from the photon source 701 and directs it through lens arrays 704 and 705. These help to more evenly distribute illumination intensity and the lens shape dictates the shape of the illumination system exit pupil. Optical sub-systems 708(a) and 708(b) contain MMDMs that achieve anamorphic magnification of the shape of the illumination system exit pupil. They can also act to introduce or remove aberration or distortion. The image from 711(a), 711(b), and 711(c), is magnified and projected through a projection lens system 713.

FIG. 7 is a schematic of a variable optical property element 800 that uses cylindrical lenses of complimentary curvature 803 and 805 with cavities 802 and 804 filled with Liquid Crystal material whose refractive index can be varied for appropriately polarised light to match or to be higher than the refractive index of materials 803 and 805. When the Liquid Crystal material index of refraction matches that of the lenses, the sub-system acts as a plate of homogeneous index of refraction. When Liquid Crystal material index of refraction is higher than that of the materials 803 and 805, the sub-system acts to achieve anamorphic magnification. The succession of high and low values of refractive index in 802 and 804 separated by cylindrical surfaces creates a cylindrical lens of certain uni-axial power having the effect of making the rays in the plane of the figure converge while the rays in the plane perpendicular to the plane of the figure do not. Similarly, 804 and 805 create a diverging lens of adapted power to compensate for change of focus caused by the anamorphic magnification of 802 and 803.

FIG. 8 shows an illumination system including an array 905 of elements 800, one matched to each lens of an illumination lens array 904. Since the shape of the illumination system exit pupil is dictated by the shape of the lenses in the illumination array 904, changing the shape of each lens in 904 with the corresponding system in 905 achieves the effect of changing the shape of the illumination system exit pupil.

In operation the projection display system has an optical system including an optical element or elements with variable optical properties, and a controller for varying the optical properties dynamically. The controller uses known or measured data for an image to be displayed, such as its radiometric and geometric characteristics and its illumination wavelengths, to generate the control signals. These control signals are generated in order to achieve the advantages described herein.

The variable optical property optical element(s) can comprise: a mirror with variable optical surface shape, a lens with variable optical surface shape, a lens with variable refractive characteristics, and a lens with variable diffractive characteristics.

The variable optical property optical elements have the following characteristics: fast response time, low cost, high robustness, low and/or high order image aberration correction or creation ability, low and/or high order image geometric distortion correction or creation ability, and efficiency in light reflection or transmission. The micro-machined deformable mirror (MMDM) 150 with a sufficient number of actuation channels is one such variable optical property element. The liquid crystal (LC) lens 800 with modal wavefront phase retardation ability has some of these characteristics. A pixellated liquid crystal on silicon (LCOS) lens with zonal wavefront phase retardation also has some of these characteristics.

The variable optical property optical element(s) can be positioned in any/all of the following locations: within an illumination optical system, after an illumination optical system, on/within a source image forming device, before an image projection optical system, within an image projection optical system, and after an image projection optical system. One factor which can influence the choice of position is that a typical variable optical property element has small diameter relative to conventional optical elements such as lenses. Hence the variable optical property element can be positioned at or near an aperture-limiting stop. If geometric distortion is required then the variable optical property element can be more effectively positioned at or near an intermediate real image.

The controller receives inputs from any or all of: an illumination control system, a wave-front sensing system, a source image forming device, a mechanical positioning and sensing system, a projected image range-estimation system, a projected image sensing system, an image content analysis system, a scene synthesis system, an image synthesis system, a video generation system, an environmental condition sensing system, a manual adjustment system controlled by an observer, and an observer eye-tracking system.

The control system performs data processing using some or all of:
A pre-calculated table of control signals for correction or creation of image aberration, for correction or creation of image geometric distortion, and for correction or creation of enhancements to the observer's perception. The controller's inputs dictate control signals to be used from the precalculated table).
Algorithms to dynamically calculate best projected image quality as part of an open-loop control system.
Inputs from wave-front sensing and other systems to find best projected image quality as part of a closed-loop control system.
Models/algorithms/heuristic approximations of the observer's perception.

The control system outputs may include:
control signals for the variable optical property element(s),
control signals for the illumination control system,
control signals for an image source forming device,
control signals for the mechanical positioning system, and/or
control signals for any system from which it receives input.

By providing a variable optical property element with such control, the invention achieves improved projected image quality and/or enhanced image perception by an observer.

It will be appreciated that the invention achieves a reduction in the complexity of the optical system, the number of optical elements, the number of optical surfaces, size and the mass of the system, the manufacturing precision required for each element, and the magnitude of mechanical positioning motion required. It also achieves improvements in the displayed image quality by reducing the amount of image aberration and by taking into account the characteristics of the observer's perception of the displayed image.

As an example, referring again to FIG. 1, consider the use of the variable optical property element 1 to allow an optical system designed for monochromatic illumination to achieve good performance with polychromatic illumination. In a projection system using a single electronic image formation device with field-sequential illumination (as achieved with an illumination wavelength selection device such as a colour wheel 5(b), or with different wavelength generating devices such as light-emitting diodes) the control system 2 receives signals from the illumination control system 6 indicating the current illumination wavelength(s) and generates the appropriate signals for the variable optical property element 1 such that it compensates for the difference in refraction or diffraction of the optical system due the change in wavelength. Thus system operation is controlled in an open-loop manner.

An alternative to open-loop control of system operation is to use iterative closed-loop control, receiving input from the wavefront sensor within or after the optical system, to correct wavefront distortion continuously, or occasionally, during system operation.

As another example, consider the use of the variable optical property element 607 in the part of the optical system that directs light from the photon source 601 onto the source image forming device 612, as shown in FIG. 5. If the source image forming device 612 is reflective such that incident wavefront shape is preserved then the variable optical property element 607 can operate to introduce or to correct image aberration or image geometric distortion through the image projection lens system 613 that has not necessarily been designed to achieve such levels of aberration or distortion, nor need it have been designed to incorporate a variable optical property element as have those of FIGS. 1 and 2. Control signals appropriate to the state of image projection lens system 613 magnification and focus are found through a calibration procedure as described above.

If the source image forming device 612 is highly diffractive or otherwise such that incident wavefront shape is not preserved, and if the image projection lens system 612 is designed to operate with a variable optical property element 607 positioned before the source image forming device 612, as shown in FIG. 5 for example, then projection lens system 613 design can be simplified. This is because the variable optical property element 607 can be controlled by the control system 2 to ensure that source image illumination is optimised to the state of image projection lens system 613 magnification and focus. Control signals appropriate to the state of image projection lens system 613 magnification and focus are found through a calibration procedure as described above.

For optical systems that have a range of states of magnification and focus, the calibration procedure can be undertaken for a subset of states. Control signals for other states can be determined through suitable interpolation between those found for the calibrated states and stored in a look-up table for access by the control system. States of magnification and focus can be measured by sensors of optical element position, these can be used to select or to interpolate the appropriate control signals.

Alternatively an observer may use a manual adjustment system 10 of FIG. 1 to select or generate control signals, found through a calibration procedure or otherwise, appropriate to the state of magnification and focus.

As another example, consider the use of a variable optical property element to perform the function of the focus element/group in a conventional optical system. If the variable optical property element is capable of generating or removing the appropriate amount of defocus, then it can be used compensate for the required change of distance from the centre of the optical system to the source image when magnification is changed, i.e. defocus is used to modify the optical distance to the source image so that it remains correct. This avoids the requirement for a conventional focus element/group, and its associated mechanical positioning systems. A similar approach can be taken to replace elements/groups from a zoom lens system of variable magnification, i.e. a variable optical property element with an appropriate amount defocus is used to vary the effective focal length of the entire optical system.

As another example, consider the use of a variable optical property element to correct aberrations from the projection lens periphery when the lens is translated with respect to the image source so as to reposition the projected image without keystone image geometric distortion. If the variable optical property element is capable of generating or removing appropriate amounts of asymmetric distortion, as is the MMDM, then this can be used to compensate for the distortion introduced when light passes through the higher distortion periphery of translated regular diameter lenses. The conventional alternative is to use larger diameter lenses such that light passes through the lower aberration centre only, even when the lens is translated.

The variable optical property element may be used to correct or introduce image geometric distortion, as is required, for example, when projecting onto a 2-D surface not normal to the axis of the optical system, or onto a 3-D non-planar surface, or to achieve anamorphic magnification of the image. This is most easily achieved when the variable optical property element is positioned at or near an intermediate image in the optical system. FIG. 4 shows an optical subsystem in which an intermediate image is formed between two variable optical property elements with cylindrical power.

These are used to achieve anamorphic magnification. The calibration procedure required to determine the appropriate control signals for the variable optical property element can be a closed-loop iterative approach, as described above, but using an image geometric distortion sensing system (e.g. a camera for image acquisition and a suitable image processing system) instead of a wavefront sensor.

The variable optical property element can be used to change the geometric and radiometric characteristics, such as shape and intensity distribution, of the area illuminated on the source image formation device without significantly reducing the amount of illumination passing through the system, and thus image brightness. This is useful for the display of imagery with different aspect ratios, for example. To effect such a change in the shape of the exit pupil of the illumination system, the variable optical property element modifies the shape of the aperture-limiting stop of the illumination system. If there is only one real stop, such as the exit pupil of an integrator rod, then a single variable optical property element can be used to effect the change, as illustrated in FIG. 5. Referring to FIGS. 6, 7 and 8, if there are multiple real stops, such as those in “fly's eye” integrating lens arrays, then a variable optical property element is needed for each stop.

The variable optical property element may be used to compensate for low manufacturing and/or assembly precision in the optical system. Through suitable calibration procedures, for example, distortion due to low precision is measured for various states of the optical system and the appropriate control signals for the variable optical property element found to correct it.

A variable optical property element may be used to compensate for aberrations caused by the use of aspherical optical elements in the optical system, in particular those which arise off-axis. Aspherical elements have been used to reduce the number of spherical elements required in the optical system. However their off-axis performance is limited and conventional spherical elements are required to compensate for this. This compensation can be achieved instead with a variable optical property element, thus further reducing the requirement for spherical elements. Through a suitable calibration procedure, as described above, for example, distortion due to aspherical elements is measured for various states of the optical system and the appropriate control signals for the variable optical property element found to correct it.

A variable optical property element may be used to compensate for optical variations due to environmental conditions such as temperature or humidity. Certain optical materials, such as plastics, are more susceptible to this problem. A temperature or humidity sensor can be interfaced to the control system, which, using a model of the relationship between temperature or humidity and optical variation, sends the appropriate control signals to the variable optical property element to correct the temperature- or humidity-induced optical variation during system operation.

A variable optical property element may be used to reduce the number of refractive surfaces in the optical system. This reduces the number of unwanted reflections at each refractive surface and so reduces the amount of stray light in the system which can reduce image contrast and brightness.

A variable optical property element with an appropriate amount of tip and/or tilt may be used to allow picture elements on the source image forming device to be projected onto a variety of different spatial positions in the projected image. This can have the effect of increasing the picture element resolution of the projected image to a number greater than the number of picture elements on the source image forming device. The resulting image is formed as a sequence of fields displayed sufficiently rapidly, where each field has at most the picture element resolution of the source image forming device.

In this case a variable optical property element can also be used to remove distortion caused by the optical system when light from individual picture elements at unique spatial positions in the source image forming device is projected to a variety of spatial positions in the projected image. The distortion can be measured, and the appropriate control values determined, through the calibration procedures described above.

A variable optical property element may be used to introduce or correct aberrations that affect the observer's perception. One perceptual problem in field sequential illumination systems is pixel colour separation due to movement of the retina between colour fields (i.e. the “rainbow effect.”). Slight defocus or other aberration can be introduced by the variable optical property element for a fraction of the field display period to mitigate against this effect. This requires trigger signal for each colour field from the illumination control system to the control system. Similarly, slight defocus or other aberration can be introduced by the variable optical property element to mitigate against perception of pixel boundaries (i.e. the “screen door effect.”) When an observer's eye tracking system is available then the control system can use its input to control the variable optical property element to optimise image quality (e.g. through the minimisation of image aberration) in the region of the observer's regard only, rather than across the entire field of the displayed image. This is advantageous because a variable optical property element such as an MMDM has limited amplitudes for each of its possible modes of wavefront deformation. If all amplitudes are available for the improvement image quality in a specific region then there is an increased probability of achieving optimal correction than when improvement over the entire field is required.

The invention is not limited to the embodiments described but may be varied in construction and detail.

1-28. (canceled)

29. An image projection display system comprising a source image formation device, an optical system for illumination and projection of the source image, said optical system comprising at least one variable optical property element, and a controller for controlling optical properties of said variable optical property element according to desired projection display requirements.

30. The image projection display system as claimed in claim 29, further comprising an illumination control system for controlling illumination of the source image; and wherein the controller receives and processes inputs from the illumination control system.

31. The image projection display system as claimed in claim 29, wherein the controller receives and processes inputs from the source image formation device.

32. The image projection display system as claimed in claim 29, wherein the controller receives and processes inputs from a mechanical positioning system.

33. The image projection display system as claimed in claim 29, wherein the controller receives and processes inputs from a manual adjustment system.

34. The image projection display system as claimed in claim 29, wherein the controller receives and processes inputs from an observer eye-tracking system.

35. The image projection display system as claimed in claim 29, wherein the controller receives and processes inputs from a wavefront sensing system.

36. The image projection display system as claimed in claim 29, wherein the controller receives and processes inputs from a displayed image sensing system.

37. The image projection display system as claimed in claim 29, wherein the controller receives and processes inputs from an environmental condition sensing system.

38. The image projection display system as claimed in claim 29, wherein the controller operates to introduce or to correct image aberration; and wherein the controller operates to introduce or to correct image geometric distortion; and wherein the controller operates to introduce or to correct aberration in the illumination system.

39. The image projection display system as claimed in claim 29, wherein the controller operates to introduce or to correct geometric distortion of the exit pupil of the illumination system.

40. The image projection display system as claimed in claim 29, wherein the controller comprises a look-up table of data for control values, indexed on inputs.

41. The image projection display system as claimed in claim 29, wherein the controller implements a closed-loop control system.

42. The image projection display system as claimed in claim 29, wherein the controller implements an open-loop control system.

43. The image projection display system as claimed in claim 29, wherein the controller controls the variable optical property element to change optical geometric and radiometric characteristics including shape and intensity distribution of an area illuminated on the source image formation device without reducing the amount of illumination passing through the system, and thus image brightness.

44. The image projection display system as claimed in claim 43, wherein the controller controls the variable optical property element to cause display of images with different aspect ratios; and wherein the controller causes a change in the shape of an exit pupil of the illumination system, by the variable optical property element modifying the shape of the aperture-limiting stop.

45. The image projection display system as claimed in claim 44, wherein the stop is an exit pupil of an integrator rod.

46. The image projection display system as claimed in claim 44, wherein the stop is a combination of overlapping exit pupils of an array of lenses.

47. The image projection system as claimed in claim 29, wherein the variable optical property element comprises one or a pair of deformable mirrors for anamorphic magnification of the shape of an exit pupil.

48. The image projection system as claimed in claim 29, wherein the variable optical property element comprises a plurality of lenses separated by liquid crystal material the refractive index of which can be varied by the controller.

49. The image projection system as claimed in claim 48, wherein the lenses are cylindrical with opposed complementary curvatures.

50. The image projection system as claimed in claim 48, wherein the controller varies polarised light to match or to be higher than the refractive index of the lenses, and when the liquid crystal material index of refraction matches that of the lenses, the element acts as a plate of homogeneous index of refraction.

51. The image projection system as claimed in claim 48, wherein the controller varies polarised light to match or to be higher than the refractive index of the lenses, and when the liquid crystal material index of refraction matches that of the lenses, the element acts as a plate of homogeneous index of refraction; and wherein the controller operates such that when liquid crystal material index of refraction is higher than that of the lenses the element acts to achieve anamorphic magnification, and a succession of high and low values of refractive index in the liquid crystal material creates a cylindrical lens of uni-axial power having the effect of making light rays in one plane converge while the rays in an orthogonal plane do not.
